(19) United States
(12) Patent Application Publication
(10) Pub. No.: US 2025/0133079 A1
(43) Pub. Date: Apr. 24, 2025

(54) HOME NETWORK SYSTEM BLOCKING UNAUTHORIZED DEVICE AND METHOD OF BLOCKING UNAUTHORIZED DEVICE IN HOME NETWORK SYSTEM

(71) Applicant: Security Platform Inc., Seongnam-si (KR)

(72) Inventors: Jeong Su SONG, Ansan-si (KR); Youn Ho LEE, Ansan-si (KR); Hyun Kook YEO, Gwangju-si (KR); Yeon Hwa KONG, Seoul (KR); Min Sung LEE, Guri-si (KR)

(21) Appl. No.: 18/630,339

(22) Filed: Apr. 9, 2024

(30) Foreign Application Priority Data
Oct. 18, 2023 (KR) 10-2023-0139607

(51) Int. Cl. H04L 9/40

(52) U.S. Cl. CPC H04L 63/0876; H04L 63/0272

(57) ABSTRACT

A method of securing a home network system applied to an apartment building includes providing a home server connected to a network, a plurality of home network devices, a VPN server installed between the home server and the home network devices, and VPN gateways individually installed for the home network devices. The method also includes extracting an IP and a MAC address of a connected device using a local packet analyzer by means of VPN gateways. The method also includes detecting alteration of the IP or the MAC address of the connected device using a connection log table by means of the VPN gateways. The method also includes defining and blocking the connected device as an unauthorized device by means of a communication blocker of the VPN gateways when an alteration ratio of the IP or the MAC address of the connected device is a predetermined danger ratio or more.

### CROSS-REFERENCE TO RELATED APPLICATION

The present application claims priority to Korean Patent Application No. 10-2023-0139607, filed Oct. 18, 2023, the entire contents of which are incorporated herein for all purposes by this reference.

### BACKGROUND

### Technical Field

The present disclosure relates to security of a home network system and, more specifically, a method of practically securing a home network system, the method being able to flexibly deal with unauthorized devices in consideration of replacement of the device or temporal use of a management device rather than unconditionally blocking the unauthorized devices.

### Description of the Related Art

FIG. 1 is a diagram illustrating a home network system for an apartment building of the related art.

Referring to FIG. 1, a home network system for an apartment building of the related art may include a home server 10, a plurality of home network devices 11˜13, and a back bone 20. The home network devices 11˜13 such as a wall pad can be provided for respective households and the back bone 20 can be a passage through which a packet passes by binding the home network devices 11˜13 installed at respective households in a network.

In the home network system of the related art, the home network device of one household can be directly connected with the home network device of another household as long as the IP is known. The households can control the entrance door, lights, heating/cooling, ventilation, cameras, etc. through the home network devices 11˜13, respectively, but when the home network devices 11˜13 are hacked, the problem that outsiders can acquire sensitive information may be brought up. Further, as IoT devices are generalized, such IoT devices can be connected to wall pads or other home network devices, but the danger of damage due to hacking of IoT devices through these paths is greatly increasing, and accordingly, network separation among households is increasingly required.

Network separation in an apartment building means the technology of separating networks for respective households. In apartment buildings such as a multiplex housing and a row house building, all of the units in the complex can be connected to one network and there is the danger of spread of damage to other households when one household is hacked. In order to prevent this problem, it is possible to cut the connections between households by separating networks between the households.

Network separation can be classified into two types of physical network separation and logical network separation.

‘Physical network separation’ is a technology of physically separating networks by constructing both of an external network and an internal network. Physical network separation has the defect that it has high security, but requires a high cost for construction and it is difficult to change the environment after designing.

‘Logical network separation’ is a technology of separating networks through a virtualization technology. Representatively, there is a virtual private network (VPN) that constructs virtual tunnels (data transmission passages) connected only to respective households in a network connecting a server and the households. Logical network separation does not require physical installation of many networks, so the construction cost is low, but there is the inconvenience that it is impossible to use existing server and wall pads as they are in order to use a VPN and it is required to newly change VPN setting not only in a server, but the wall pad of each household in order to form virtual private networks.

An “Image monitoring system and method” that uses a VPN has been disclosed in Korean Patent No. 10-0920171. The document describes that it is possible to improve communication security between a client and a server by performing authentication and communication using a VPN in a monitoring system in an apartment building. This is common logical network separation, but has the defect that it is required to install a separate authentication server and existing modules before the VPN technology is applied cannot be used as they are as a client module and a server module.

A “Smart wall pad performing self security monitoring and operation method of the same” has been disclosed in Korean Patent No. 10-2498603. The wall pad includes a monitoring module, a notification module, a storage module, etc. for security and can check by itself whether it has been attacked. This has the defect that the wall pad has to be replaced with new one and wall pads of the related art cannot be used.

It is possible to prevent connection of unauthorized devices for security. However, it may be possible to temporarily use another device that is normally operated in order to replace a device with new equipment or determine whether the device has a problem, but when even this device is determined and blocked as an unauthorized device, it may cause inconvenience in practical operation of a home network system.

Further, it is also possible to temporarily stop the security function of the entire home network system in order to prevent this inconvenience, but it is dangerous in that a blind spot is generated in security of the entire system and it may also be troublesome to change the setting of the system.

### SUMMARY

The present disclosure provide a home network system that can sense connection of unauthorized devices, that is, unauthorized home network devices or other devices that can back in a VPN gateway and can prevent such connection under practical conditions when applying logical network separation in a home network system of an apartment building, and a method of securing the home network system.

The present disclosure provides a home network system that can limit connection of unauthorized devices to the home network system to which network separation is applied in consideration of practical maintenance and management processes rather than unconditionally blocking the unauthorized devices, and a method of securing the home network system.

The present disclosure provides a home network system that enables network separation even without replacing a home server and a wall pad or changing setting before network separation and can automatically set limitation of connection of unauthorized devices, and a method of securing the home network system.

According to an exemplary embodiment of the present disclosure for achieving the objectives of the present disclosure described above, a method of securing a home network system applied to an apartment building composed of a plurality of unit spaces may include: providing a home server connected to a network, a plurality of home network devices installed for unit spaces, respectively, a VPN server installed between the home server and the home network devices, and VPN gateways individually installed for the home network devices between the home network devices and the VPN server, wherein the VPN gateways each include a first bridge terminal configured to communicate with a corresponding home network device, a local packet analyzer configured to analyze a packet provided from the first bridge terminal, a connection log table configured to store an IP and a MAC address of a connected device acquired from the local packet analyzer, and a communication blocker configured to selectively block communication of the connected device; extracting the IP and the MAC address of the connected device using the local packet analyzer by means of the VPN gateways; detecting alteration of the IP or the MAC address of the connected device using the connection log table by means of the VPN gateways; and defining and blocking the connected device as an unauthorized device by means of the communication blocker of the VPN gateways when an alteration ratio of the IP or the MAC address of the connected device is a predetermined danger ratio or more.

It is preferable to immediately block a connected device when the connected device is an unauthorized device registered in a blacklist, but unconditionally blocking new equipment may spoil flexibility.

Accordingly, it is possible to maintain a connection log table that records the IP and the MAC address of a connected device and it is possible to record the IP and the MAC address of the connected device with regular intervals or randomly.

An alteration ratio (AR) of the IP or the MAC address of a connected device may be the number of data of connected devices altered with respect to the number of the entire data stored in the connection log table based on the IPs and the MAC addresses of home network devices or the IPs and the MAC addresses of devices recorded up to now. For example, when the connection log table records the IPs and the MAC addresses of thirty connected devices and when the number of data recorded by alteration of the IPs and the MAC addresses of connected devices is 2, the alteration ratio (AR) may be calculated as 2/30.

Further, when a danger ratio (DR) is defined as 10% and when connection log of a connected device, which is different from at least one of the IP and the MAC address of a home network device as the result of comparing the IP and the MAC address of the connected device, is 10% or more or recorded four times, it is possible to determined the device as an unauthorized device.

When it is determined that an unauthorized device is connected, the communication blocker can block connection of the unauthorized device and can block communication of the VPN gateway or stop the operation of the VPN gateway.

The local packet analyzer may acquire an IP and a MAC address of a connected device by analyzing an ARP packet that is transmitted from the connected device.

In the home network system, the VPN server may include an IP route table configured to store an IP and a MAC address of the home network devices and an IP of the VPN gateways, and the VPN gateways may include an authorized device table configured to store an IP and a MAC address of home network devices registered in the IP route table.

When a home network device is broken, it is possible to mount and test a new home network device, and a manager can perform test operation to the extent that the degree of connection is maintained under a danger ratio (even though the new home network device is connected. Further, depending on cases, in order to determine that the home network device 11 is broken, it is also possible to whether a home network device has a problem or the network has a problem by temporarily installing another home network device that is normally operated.

When alteration using a same connected device is not continued and is frequently repeated, the communication block of the VPN gateways determines that it is habitual alteration rather than determine that it is a temporal situation, thereby being able to determine and block the connected device as an unauthorized device even though the alteration ratio (AR) is a danger ratio (DR) or less. For example, when alteration of a new device and a home network device is repeated two or more times, it is also possible to determine the connected device as an unauthorized device even though the alteration ratio (AR) is a danger ratio (DR) or less.

When a home network device is replaced with a new home network device, the replacement can be authorized by the home serer or the VPN server. To this end, the VPN server can authenticate the IP and the MAC address of a home network device that is registered in the IP route table, and the authorized device table of the VPN gateway can be updated with reference to the IP route table of the VPN server.

The VPN gateway may include an unauthorized device table configured to store an IP or a MAC address of a device defined as an unauthorized device, the communication blocker may block a device of a MAC address included in the unauthorized device table even though AR of the device is the danger ratio or less when the device is connected, and in this case, an unauthorized IP may be recorded and stored.

A home network system according to the embodiment may include a separate back bone for connecting the home server and the home network devices and the VPN server may make communication between the home network devices and the home server be processed using a back bone gateway in priority to the back bone.

According to an exemplary embodiment of the present disclosure for achieving the objectives of the present disclosure described above, a home network system applied to an apartment building composed of a plurality of unit spaces may include: a home server connected to a network, a plurality of home network devices installed for unit spaces, respectively, a VPN server installed between the home server and the home network devices, and VPN gateways individually installed for the home network devices between the home network devices and the VPN server, wherein the VPN gateways each include a first bridge terminal configured to communicate with a corresponding home network device, a local packet analyzer configured to analyze a packet provided from the first bridge terminal, a connection log table configured to store an IP and a MAC address of a connected device acquired from the local packet analyzer, and a communication blocker configured to selectively block communication of the connected device; the local packet analyzer of the VPN gateways extracts the IP and the MAC address of the connected device, and the communication blocker detects alteration of the IP or the MAC address of the connected device using the connection log table, and defines and blocks the connected device as an unauthorized device when an alteration ratio of the IP or the MAC address of the connected device is a predetermined danger ratio or more.

The local packet analyzer may acquire the IP and the MAC address of the connected device by analyzing an ARP packet that is transmitted from the connected device and may store an IP and a MAC address acquired from the connected device in a connection log table.

The VPN server may include an IP route table configured to store an IP and a MAC address of the home network devices and an IP of the VPN gateways, and the VPN gateways may include an authorized device table configured to store an IP and a MAC address of home network devices registered in the IP route table. Accordingly, the VPN gateway may not block a device included in the authorized device table, that is, a home network device even though the device is connected over a danger ratio.

Further, when alteration of a connected device is repeated two or more times and when it is determined that a new device has been connected before and after an authorized home network device, the communication blocker may determine that it is an illegal purpose and may define and block the connected device as an unauthorized device even though an alteration ratio according to connection of the device is a danger ratio or less.

The VPN gateway may include an unauthorized device table configured to store an IP or a MAC address of a device defined as an unauthorized device, the communication blocker may block a device of a MAC address included in the unauthorized device table even though AR of the device is the danger ratio or less when the device is connected. The unauthorized device table may be continuously updated in accordance with connection blocking.

The home network system may include a separate back bone for connecting the home server and the home network devices and the VPN server may make communication between the home network devices and the home server be processed using a back bone gateway in priority to the back bone.

In the present disclosure, an apartment building may be understood as a building or a structure that includes a plurality of unit spaces, can be expanded to various concepts including not only a multiplex housing and a row house building, but also an office building, a factory, etc., and can be applied to physically separated structures as well.

According to the home network system and a method of securing the home network system of the present disclosure, it is possible to sense connection of an unauthorized device, that is, a home network device that has not been authorized and can block the device under practical conditions at a VPN gateway when applying logical network separation in a home network system.

In the home network system and a method of securing the home network system of the present disclosure, it is possible to allow connection of a new device and determine an unauthorized device in accordance with a logical sequence without stopping the entire system in a home network system, in which network separation is formed, in consideration of practical maintenance and management processes rather than unconditionally blocking a new device to a VPN gateway.

The home network system and the method of securing the home network system of the present disclosure can implement network separation even without replacing a home server and a wall pad or changing setting before network separation and can automatically set limitation of connection of unauthorized devices.

Since the home network system of the present disclosure enables a manager to maintain an existing management system as it is before network separation, there is the advantage that a manager can directly apply the home network system without new training or upgrading a manual in the same way before and after a virtual private network is started.

### BRIEF DESCRIPTION OF THE DRAWINGS

FIG. 1 is a diagram illustrating a home network system for an apartment building of the related art;

FIG. 2 is a diagram illustrating a home network system and a VPN gateway to which a network separation technology according to an embodiment of the present disclosure has been applied;

FIG. 3 is a diagram illustrating the functions of a VPN gateway and a VPN server in the home network system of FIG. 2; and

FIGS. 4 to 6 are diagrams illustrating the VPN gateway of FIG. 2 and the function thereof.

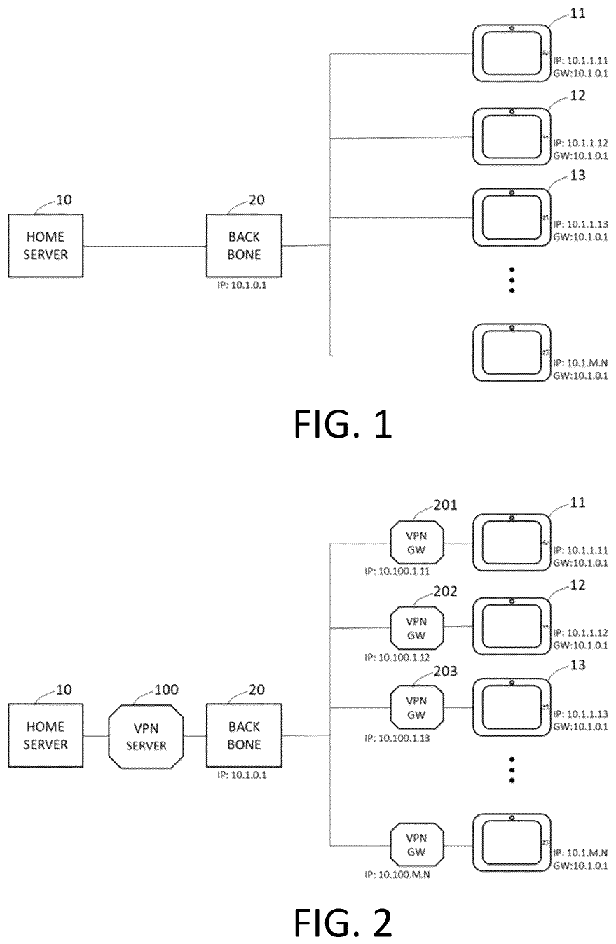

### DETAILED DESCRIPTION

Hereafter, preferred embodiments of the present disclosure will be described in detail with reference to the accompanying drawings, but the present disclosure is not limited or restricted to the embodiments. For reference, the same reference numerals substantially indicate the same components in the description, it is possible to refer to the matters shown in other figures under this rule, and matters that are determined as being apparent or repetitive to those skilled in the art may be omitted.

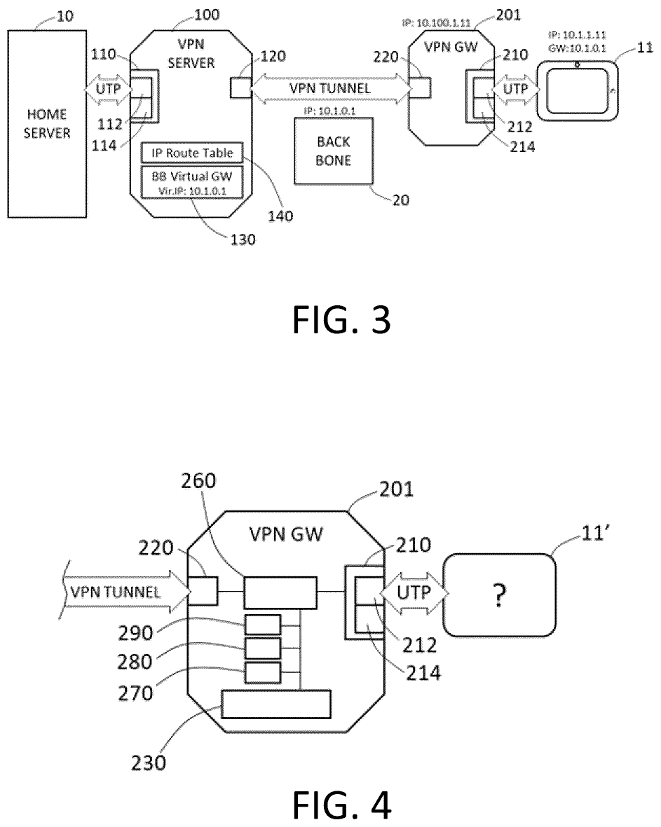

FIG. 2 is a diagram illustrating a home network system and a VPN gateway to which a network separation technology according to an embodiment of the present disclosure has been applied, FIG. 3 is a diagram illustrating the functions of a VPN gateway and a VPN server in the home network system of FIG. 2, and FIGS. 4 to 6 are diagrams illustrating the VPN gateway of FIG. 2 and the function thereof.

Referring to FIGS. 2 to 6, VPN gateways 201˜203 according to the embodiment can be applied to construction of a virtual private network for network separation in a home network system for an apartment building. The entire configuration of a home network system for an apartment building can be implemented by additionally installing a VPN server 100 and VPN gateways 201˜203 on a network with a home server 10, a plurality of home network devices 11˜13, and a back bone 20 installed on the network.

The VPN gateways 201˜203 may be additionally installed to the home network devices 11˜13 installed for respective households and the VPN server 100 may be installed between the VPN gateways 201˜203 and the home server 10. The gateways 201˜203 and the VPN server 100 can be installed on an existing network and there is the advantage that it is possible to form a virtual private network for logical network separation while installing them on an existing network.

There is also an example of additionally forming a virtual private network in a home network system in the related art. However, a method of additionally installing a virtual private network in the related art requires replacement of home network devices and the equipment of a home server or the setting for each household for a VPN, but the virtual private network according to the embodiment is different in that it is possible to achieve network separation only by installing the VPN gateways 201˜203 and the VPN server 100 on a network without changing the setting of the home network devices 11˜13 and the home server 10.

To this end, the VPN gateways 201˜203 may include a first bridge terminal 210 for communication with the home network devices 11˜13 and a first intermediate communication terminal 220 for communication with the VPN server 100. Further, the VPN server 100 may include a second bridge terminal 110 for communication with the home server 10 and a second intermediate communication terminal 120 for communication with the VPN gateways 201˜203.

The first bridge terminal 210 may include a first end communication interface 212 and a first TAP interface 214 and the second bridge terminal 110 may include a second end communication interface 112 and a second TAP interface 114. The first end communication interface 212 and the second end communication interface 112 can use communication interfaces that are used on the existing network, and can use a UTP cable type that is generally used can be used. Further, as the end communication interfaces, the types that use FTP, STP, S-STP, S-FTP cables, etc. can be used.

In the first bridge terminal 210 and the second bridge terminal 110, respectively, the first TAP interface 214 and the second TAP interface 114 may be added between communication interfaces according to UTP cable type. The TAP interfaces can use an interface that provides a data link layer of TCP/IP layers to a network interface to be able to control a network packet, and in the embodiment, the TAP interfaces can be used in linkage with end communication interfaces such as a UTP.

The first intermediate communication terminal 220 and the second intermediate communication terminal 120 that connect the VPN gateways 201˜203 and the VPN server 100 can also use the type that uses a UTP cable that was installed before, and can use an existing network installed in an existing home network system.

However, since the first bridge terminal 210 and the second bridge terminal 110 include the first TAP interface 214 and the second TAP interface 114, respectively, the VPN gateways 201˜203 and the VPN server 100 can form VPN terminals when a virtual private network is started.

As in FIG. 3, VPN tunnels connecting the intermediate communication interfaces can be formed between the VPN gateways 201˜203 and the VPN server 100. The VPN gateways 201˜203 can form a network-separated state from the VPN server 100 through the VPN tunnels.

The VPN server 100 includes a back bone virtual gateway 130 that can replace the actual back bone 20 and the back bone virtual gateway 130 can perform processing in priority to the actual back bone 20 in communication through the VPN tunnels. To this end, the back bone virtual gateway 130 can be given a virtual IP (10.1.0.1) that is the same as the IP, for example, (10.1.0.1) of the actual back bone 20, and can transmit signals, which are transmitted from the home network devices 11˜13 or the home server 10, to the home server 10 or other home network devices not through the actual backbone 20 by preferentially processing signals corresponding to the IP (10.1.0.1) of a back bone. As a result, the home network devices 11˜13 and the home server 10 both can use the existing network as if there is the actual backbone 20, and even though a virtual private network is additionally formed, it is not required to change the setting of the home network devices 11˜13 or the home server 10.

Since it is not required to change existing setting, it is possible to achieve logical network separation using a virtual private network without replacing or upgrading equipment only by installing the VPN gateways 201˜203 and the VPN server 100 according to the present disclosure even in old home network systems in which a virtual private network essentially cannot be installed.

Further, it is possible to satisfy the network separation rule describing that home network devices and a home server designed and manufactured for an existing home network system have to use virtual private networks while maintaining the existing design, so the companies that manufacture and install home network devices and a home server also can use the existing equipment without developing new equipment.

The back bone virtual gateway 130 can process information corresponding to the IP, for example, (10.1.0.1), of a back bone in priority to the actual back bone 20 in communication with the home network devices 11˜13 through the VPN gateways 201˜203, and the information may not be transmitted to the actual back bone 20. That is, signals going to the home server 10 from the home network devices 11 ˜13 or signals going to the home network devices 11˜13 from the home server 10 can be transmitted therebetween while detouring through the VPN tunnels without passing through the actual back bone 20.

The information about the IP of the back bone 20 may be defined as a plurality of items other than (10.1.0.1), and similar to the case in which the actual back bone 20 process signals for a plurality of IPs, the back bone virtual gateway 130 according to the embodiment can also process signals for a plurality of IPs as a substitute.

A worker can manually input the IP information of a back bone that is input to the back bone virtual gateway 130 in the embodiment while additionally installing the VPN gateways 201˜203 and the VPN server 100.

The VPN server 100 may include an IP route table 140 that stores the IPs of the home network devices 11˜13, MAC addresses, the IPs of the VPN gateways 201˜203 individually connected to the home network devices 11˜13, etc.

When receiving a signal corresponding to a specific home network device 11˜13 from the home server 10, the VPN server 100 can search for the information of the VPN gateway 201˜203 corresponding to the home network device 11˜13 by referring to the IP route table 140 and can transmit the signal to the VPN gateway 201˜203. For example, when a signal that is transmitted from the home server 10 corresponds to the IP information (10.1.1.11) of a specific home network device 11, it is possible to search for the IP information (10.100.1.11) of a matched VPN gateway 201 through the IP route table 140 and can transmit the signal to the VPN gateway 201.

The IP route table 140 may also be manually input, but, depending on cases, it is possible to receive and store automatically assigned IPs from the VPN gateways 201˜203 in the initial operation, and even after the initial operation, it is possible to update the IPs of home network devices, MAC addresses, the IPs of VPN gateways, etc. in the unit of predetermined time.

Referring to FIG. 4, a VPN gateway can acquire information about a connected device 11′ through packet analysis. To this end, the VPN gateway 201 may include a local pack analyzer 230 for analyzing packets that are transmitted from and received to a connected device 11′, a communication blocker 260 controlling communication between the first bridge terminal 210 and the first intermediate communication terminal 220, a connection log table 270 storing the IP and the MAC address of the connected device 11′ acquired from the local packet analyzer 230, an authorized device table 280 including IPs and MAC addresses of devices authorized to connect to the VPN gateway 201, and an unauthorized device table 290 including IPs and MAC addresses of devices prevented from connecting.

The local packet analyzer 230 of the VPN gateway 201 can extract the IP and the MAC address of the connected device 11′. The local packet analyzer 230 analyzes an ARP packet that is transmitted from an adjacent connected device 11′ or a home server 10, thereby being able to automatically acquire information about the IP and MAC address of the connected device 11′.

An Address Resolution Protocol(ARP) packet is a protocol for taking mapping information between a physical MAC address and a logical IP address and the local packet analyzer 230 can check the IP information, etc. of the connected device 11′ through ARP packet analysis.

An ARP packet may include a network hardware type, a protocol type, the length of a hardware address, the length of a protocol address, the MAC address of a transmitter, the IP of the transmitter, the MAC address of a receiver, the IP of the receiver, etc., and in this case, the local packet analyzer 230 can acquire the IP and the MAC address of the connected device 11′ from information including the IP and the MAC address of a transmitter and the IP and the MAC address of a receiver.

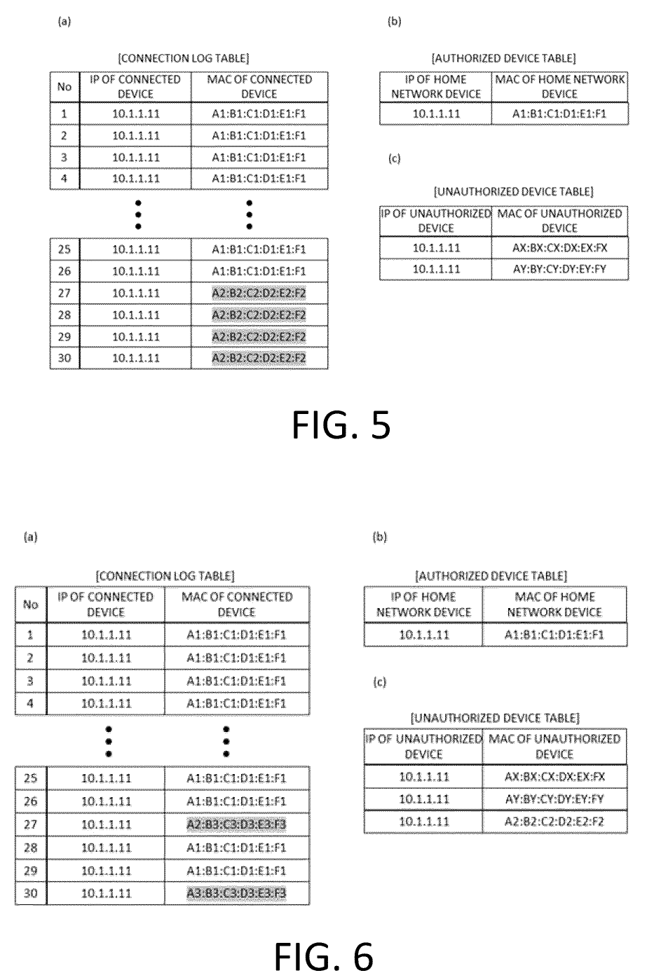

The VPN gateway 201 can receive or randomly record the IP and the MAC address of the connected device 11′ with regular intervals through a call signal. In the embodiment, the connection log table 270 can sequentially record thirty IPs and MAC addresses and the IPs and MAC addresses can be continuously updated as in FIG. 5A.

When the connected device 11′ is not a home network device 11 stored in the authorized device table 280, an alteration ratio can be calculated. The alteration ratio may be the number or the ratio of data of connected devices 11′ altered with respect to the number of the entire data stored in the connection log table 270 based on the IPs and the MAC addresses of the home network devices 11 or the IPs and the MAC addresses of devices recorded up to now. For example, when the connection log table 270 records the IPs and the MAC addresses of thirty connected devices 11′, as in FIG. 5A, and when the number of data recorded by alteration of the IPs and the MAC addresses of the connected devices recorded as Nos. 27˜30 is 4, the alteration ratio may be defined as 4/30.

The communication blocker 260 can detect alteration of the IP or the MAC address of a connected device 11′ using the connection log table 270, and can define and block the connected device 11′ as an unauthorized device when the alteration ratio of the IP or the MAC address of a connected device 11′ is a predetermined danger ratio (e.g., 3/30) or more.

When the device defined as an unauthorized device is connected, the IP and the MAC address thereof can be stored in the unauthorized device table 290 (see FIG. 5C), and when a device newly defined as an unauthorized device is connected, the IP and the MAC address thereof can be updated and stored in the unauthorized device table 290 (see FIG. 6C).

When a connected device is determined as an unauthorized device through comparison of an alteration ratio and a danger ratio, the communication blocker 260 can block connection of the unauthorized device and block communication of the VPN gateway or stop the operation of the VPN gateway.

However, when a device of a MAC address included in the unauthorized device table 290 is connected, the communication blocker 260 can immediately block the connected device even though the alteration ratio is a danger ratio or less. It is also possible to record the IP of the unauthorized device and use the IP later as various items of information.

As described above, in the home network system, the VPN server 100 may include an IP route table 140 storing the IPs and the MAC addresses of the home network devices 201˜203, that is, authorized devices and the IPs of VPN gateways. Further, the IP and the MAC address of a device authorized in correspondence to the IP of a VPN gateway stored in the IP route table 140 can be synchronized and stored in the authorized device table 280 of the corresponding VPN gateway 201.

If the home network device 11 is broken, it is possible to mount and test a new home network device, and a manager or a worker can perform test operation to the extent that the degree of connection is maintained under a danger ratio (e.g., 10%) even though the new home network device is connected. Further, depending on cases, in order to determine that the home network device 11 is broken, it is also possible to whether the originally installed home network device has a problem or the network has a problem by temporarily connecting another home network device that is normally operated.

However, when a connected device is repeated habitually rather than temporarily, it is determined as habitual replacement even though the alteration ratio of the connection does not reach a danger ratio, and the communication blocker 260 of the VPN gateway 201 can block connection of the connected device 11′.

For example, as in FIG. 6A, with a MAC address (A1: B1: C1: D1: E1: F1) registered in the authorized device table 280, when a device having a new MAC address (A3: B3: C3: D3: E3: F3) is connected and is sensed before and after a signal of an authorized device, it can be considered as an illegal purpose.

When alteration of the connected device 11′ repeats two or more times before and after an authorized device, it is possible to define and block the connected device as an unauthorized device even though the alteration ratio is a danger ratio or less, and it is possible to record the IP and the MAC address of the device as well in the unauthorized device table 290.

If an existing home network device is removed and a new home network device is mounted, authorization of the replacement can be authenticated and performed by the home server or the VPN server 100. To this end, the VPN server 100 can authenticate the IP and the MAC address of a home network device that is registered in the IP route table 140, and the authorized device table 280 of the VPN gateway 201 can be updated with reference to corresponding data in the IP route table 140 of the VPN server 100.

An alteration ratio may be 10% or more when a device included in the authorized device table, that is, the home network device 201 is newly connected, and in this case, the VPN gateway 201 may not block the device even though the alteration ratio is a danger ratio or more by referring to the authorized device table 280.

Though not shown, when a virtual private network is operated, the VPN gateway 201 may perform a process of automatically configurating an IP. For example, a network setting unit automatically creating an IP of the VPN gateway 201 using the local packet analyzer 230 of the VPN gateway 201 and the IP of the home network device 11 acquired by the local packet analyzer 230 may be included.

Assuming that an IP is generally configured in 32 bits, the network setting unit can create an IP of a VPN gateway such that the lower 16 bits of the IP of the VPN gateway 201 are the same as the lower 16 bits of the IP of a home network device. Depending on cases, the network setting unit may create an IP of a VPN gateway such that lower 24 bits of the IP of the gateway 201 are the same as the lower 24 bits of the IP of a home network device.

The local packet analyzer 230 analyzes an ARP packet that is transmitted from an adjacent home network device 11, thereby being able to automatically acquire the IP (10.1.1.11) of the individually installed home network device 11.

When the IP (10.1.1.11) of the home network device 11 is specified, the network setting unit can generate an IP of a VPN gateway as (10.100.1.11) such that the lower 16 bits of the IP of the VPN gateway are the same as the lower 16 bits of the home network device 11. For reference, the lower 16 bits of an IP may correspond to the latter two numbers of four numbers (0˜255) constituting the IP.

The VPN gateways 201˜203 can configurate their IPs by automatically referring to the IPs of the home network devices 11˜13 and the IP route table 140 of the VPN server 100 can combine and store the automatically configurated IPs of the VPN gateways 201˜203, the IPs of the home network devices 11˜13, MAC addresses, etc.

Although exemplary embodiments of the present disclosure were described above with reference to the drawings, it should be understood that the present disclosure may be changed and modified in various ways by those skilled in the art without departing from the spirit and scope of the present disclosure described in claims.

What is claimed is:

1. A method of securing a home network system applied to an apartment building composed of a plurality of unit spaces, the method comprising:
providing a home server connected to a network, a plurality of home network devices installed for unit spaces, respectively, a VPN server installed between the home server and the home network devices, and VPN gateways individually installed for the home network devices between the home network devices and the VPN server,
wherein the VPN gateways each include a first bridge terminal configured to communicate with a corresponding home network device, a local packet analyzer configured to analyze a packet provided from the first bridge terminal, a connection log table configured to store an IP and a MAC address of a connected device acquired from the local packet analyzer, and a communication blocker configured to selectively block communication of the connected device;
extracting the IP and the MAC address of the connected device using the local packet analyzer by means of the VPN gateways;
detecting alteration of the IP or the MAC address of the connected device using the connection log table by means of the VPN gateways; and
defining and blocking the connected device as an unauthorized device by means of the communication blocker of the VPN gateways when an alteration ratio of the IP or the MAC address of the connected device is a predetermined danger ratio or more.

2. The method of claim 1, wherein the local packet analyzer acquires an IP and a MAC address of a connected device by analyzing an ARP packet that is transmitted from the connected device.

3. The method of claim 1, wherein the VPN server includes an IP route table configured to store an IP and a MAC address of the home network devices and an IP of the VPN gateways,
the VPN gateways include an authorized device table configured to store an IP and a MAC address of home network devices registered in the IP route table, and
the communication blocker of the VPN gateways defines the connected device as an unauthorized device to block the connected device even though the alteration ratio of the connected device is less than the danger ratio when alteration of the connected device is repeated two or more times.

4. The method of claim 3, wherein the VPN server authenticates an IP and a MAC address of home network device that is registered in the IP route table, and
the authorized device table of the VPN gateways is updated with reference to the IP route table.

5. The method of claim 3, wherein the VPN gateways include an unauthorized device table configured to store an IP or a MAC address of a device defined as an unauthorized device, and
the communication blocker blocks a device of a MAC address included in the unauthorized device table even though the alteration ratio of the device is less than the danger ratio when the device is connected.

6. The method of claim 1, wherein the home network system includes a separate back bone for connecting the home server and the home network devices and the VPN server makes communication between the home network devices and the home server be processed using a back bone gateway in priority to the back bone.

7. A home network system applied to an apartment building composed of a plurality of unit spaces, the home network system comprising a home server connected to a network, a plurality of home network devices installed for unit spaces, respectively, a VPN server installed between the home server and the home network devices, and VPN gateways individually installed for the home network devices between the home network devices and the VPN server,
wherein the VPN gateways each include a first bridge terminal configured to communicate with a corresponding home network device, a local packet analyzer configured to analyze a packet provided from the first bridge terminal, a connection log table configured to store an IP and a MAC address of a connected device acquired from the local packet analyzer, and a communication blocker configured to selectively block communication of the connected device,
the local packet analyzer of the VPN gateways extracts the IP and the MAC address of the connected device, and
the communication blocker detects alteration of the IP or the MAC address of the connected device using the connection log table, and defines and blocks the connected device as an unauthorized device when an alteration ratio of the IP or the MAC address of the connected device is a predetermined danger ratio or more.

8. The home network system of claim 7, wherein the local packet analyzer acquires the IP and the MAC address of the connected device by analyzing an ARP packet that is transmitted from the connected device.

9. The home network system of claim 7, wherein the VPN server includes an IP route table configured to store an IP and a MAC address of the home network devices and an IP of the VPN gateways,
the VPN gateways include an authorized device table configured to store an IP and a MAC address of home network devices registered in the IP route table, and
the communication blocker of the VPN gateways defines the connected device as an unauthorized device to block the connected device even though the alteration ratio of the connected device is less than the danger ratio when alteration of the connected device is repeated two or more times.

10. The home network system of claim 9, wherein the VPN gateways include an unauthorized device table configured to store an IP or a MAC address of a device defined as an unauthorized device, and
the communication blocker blocks a device of a MAC address included in the unauthorized device table even though the alteration ratio of the device is less than the danger ratio when the device is connected.

11. The home network system of claim 7, wherein the home network system includes a separate back bone for connecting the home server and the home network devices and the VPN server makes communication between the home network devices and the home server be processed using a back bone gateway in priority to the back bone.
